(19) United States
(12) Patent Application Publication
(10) Pub. No.: US 2024/0349383 A1
(43) Pub. Date: Oct. 17, 2024

(54) EVALUATING BACKHAUL BEAMS FOR NETWORK-CONTROLLED REPEATERS

(71) Applicant: QUALCOMM Incorporated, San diego, CA (US)

(72) Inventors: Naeem AKL, Bridgewater, NJ (US); Karl Georg HAMPEL, Jersey City, NJ (US)

(21) Appl. No.: 18/435,475

(22) Filed: Feb. 7, 2024

Related U.S. Application Data
(60) Provisional application No. 63/496,664, filed on Apr. 17, 2023.

(51) Int. Cl. H04W 76/20; H04W 24/10; H04W 76/19; H04W 76/30

(52) U.S. Cl. CPC H04W 76/20; H04W 24/10; H04W 76/19; H04W 76/30

(57) ABSTRACT

Various aspects of the present disclosure generally relate to wireless communication. In some aspects, a network-controlled repeater (NCR) may receive, by an NCR mobile termination (NCR-MT) and via a control link, control information. The NCR may release, by the NCR-MT, a radio resource control (RRC) connection of the NCR-MT with a network node. The NCR may perform, by an NCR forward (NCR-Fwd), a radio frequency (RF) signal forwarding to the network node via a backhaul beam based at least in part on the control information. The NCR may cease the RF signal forwarding on the backhaul beam based at least in part on an evaluation of a condition associated with the backhaul beam for the RF signal forwarding to the network node. Numerous other aspects are described.

### CROSS-REFERENCE TO RELATED APPLICATION

This Patent application claims priority to U.S. Provisional Patent Application No. 63/496,664, filed on Apr. 17, 2023, entitled “EVALUATING BACKHAUL BEAMS FOR NETWORK-CONTROLLED REPEATERS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for evaluating backhaul beams for network-controlled repeaters (NCRs).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a network-controlled repeater (NCR) includes a memory and one or more processors, coupled to the memory, configured to: receive, by an NCR mobile termination (NCR-MT) of the NCR and via a control link, control information; release, by the NCR-MT, a radio resource control (RRC) connection of the NCR-MT with a network node; perform, by an NCR forward (NCR-Fwd) of the NCR, a radio frequency (RF) signal forwarding to the network node via a backhaul beam after the RRC connection of the NCR-MT is released and based at least in part on the control information; and cease the RF signal forwarding on the backhaul beam based at least in part on an evaluation, by the NCR-MT or the NCR-Fwd, of a condition associated with the backhaul beam for the RF signal forwarding to the network node.

In some implementations, a method of wireless communication performed by an NCR includes receiving, by an NCR-MT of the NCR and via a control link, control information; releasing, by the NCR-MT, an RRC connection of the NCR-MT with a network node; performing, by an NCR-Fwd of the NCR, an RF signal forwarding to the network node via a backhaul beam after the RRC connection of the NCR-MT is released and based at least in part on the control information; and ceasing the RF signal forwarding on the backhaul beam based at least in part on an evaluation, by the NCR-MT or the NCR-Fwd, of a condition associated with the backhaul beam for the RF signal forwarding to the network node.

In some implementations, a non-transitory computer-readable medium storing a set of instructions for wireless communication includes one or more instructions that, when executed by one or more processors of an NCR, cause the NCR to: receive, by an NCR-MT of the NCR and via a control link, control information; release, by the NCR-MT, an RRC connection of the NCR-MT with a network node; perform, by an NCR-Fwd of the NCR, an RF signal forwarding to the network node via a backhaul beam after the RRC connection of the NCR-MT is released and based at least in part on the control information; and cease the RF signal forwarding on the backhaul beam based at least in part on an evaluation, by the NCR-MT or the NCR-Fwd, of a condition associated with the backhaul beam for the RF signal forwarding to the network node.

In some implementations, an apparatus for wireless communication includes means for receiving, via a control link, control information; means for releasing an RRC connection with a network node; means for performing an RF signal forwarding to the network node via a backhaul beam after the RRC connection is released and based at least in part on the control information; and means for ceasing the RF signal forwarding on the backhaul beam based at least in part on an evaluation of a condition associated with the backhaul beam for the RF signal forwarding to the network node.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, RF chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a network-controlled repeater (NCR), in accordance with the present disclosure.

FIG. 5 is a diagram illustrating an example of a cell reselection for an NCR, in accordance with the present disclosure.

FIG. 6 is a diagram illustrating an example of invalid control information for an NCR without a cell reselection, in accordance with the present disclosure.

FIG. 7 is a diagram illustrating an example associated with evaluating backhaul beams for NCRs, in accordance with the present disclosure.

FIG. 8 is a diagram illustrating an example process associated with evaluating backhaul beams for NCRs, in accordance with the present disclosure.

FIG. 9 is a diagram of an example apparatus for wireless communication, in accordance with the present disclosure.

### DETAILED DESCRIPTION

A network-controlled repeater (NCR) may be in between a network node and a user equipment (UE). The NCR may provide amplify-and-forward operations to improve communications between the network node and the UE. The NCR, when connected to a cell associated with the network node, may use control information to perform an amplify-and-forward operation. During the amplify-and-forward operation, an NCR mobile termination (NCR-MT) may be in a radio resource control (RRC) inactive mode. An NCR forward (NCR-Fwd) may perform the amplify-and-forward operation. The control information may assume that the NCR is pointing a backhaul beam towards the cell in a first direction, and the NCR-Fwd may perform the amplify-and-forward operation accordingly. When the NCR moves to a different location or is subjected to an environment change, the NCR may still camp on the same cell (e.g., no cell reselection), but now the NCR may be pointing the backhaul beam towards the cell in a second direction. However, the control information may not be useable for the second direction, so when the NCR-Fwd attempts to perform the amplify-and-forward operation using the control information, the NCR-Fwd may forward noise and/or an unintended signal, which may degrade a performance of the NCR. Further, since no cell reselection occurred, a network node may be unaware that the NCR moved to the different location or that the environment change occurred, and so the NCR-MT does not transition out of the RRC inactive mode to obtain updated control information that corresponds to the NCR pointing the backhaul beam towards the cell in the second direction.

Various aspects relate generally to evaluating backhaul beams for NCRs. In some examples, an NCR may receive, by an NCR-MT and from a network node via a control link, control information and an indication of a condition associated with a backhaul beam for radio frequency (RF) signal forwarding to a network node. The NCR-MT may release an RRC connection of the NCR-MT with the network node. For example, the NCR-MT may transition from an RRC connected mode to an RRC inactive mode or an RRC idle mode. An NCR-Fwd may perform the RF signal forwarding to the network node via the backhaul beam after the RRC connection of the NCR-MT is released and based at least in part on the control information. The NCR-MT may perform beam measurements for the backhaul beam after the RRC connection of the NCR-MT is released (e.g., when the NCR-MT is in the RRC inactive mode or in the RRC idle mode). The NCR-MT or the NCR-Fwd may determine, based at least in part on an evaluation of the condition, that the backhaul beam is no longer suitable for the RF signal forwarding. For example, the NCR-MT may compare the beam measurements to a threshold value, associated with the condition, and when the beam measurements do not satisfy the threshold value, the NCR-MT or the NCR-Fwd may determine that the backhaul beam is no longer suitable for the RF signal forwarding. The backhaul beam not being suitable for the RF signal forwarding may also imply that the control information has become invalid. The NCR may cease the RF signal forwarding based at least in part on the evaluation, by the NCR-MT or the NCR-Fwd, of the condition. The NCR-MT may resume the RRC connection of the NCR-MT with the network node. For example, the NCR-MT may move back to the RRC connected mode. The NCR-MT may receive, from the network node, updated control information, which may be used for subsequent data forwarding.

Particular aspects of the subject matter described in this disclosure may be implemented to realize one or more of the following potential advantages. In some examples, the NCR-MT may determine when stored control information for an NCR becomes invalid based at least in part on a change of observed beam(s) of a camped cell. The change of observed beam(s) may satisfy the condition, which may cause the NCR-MT to resume an RRC connection of the NCR-MT to receive the updated control information. The updated control information may stop the NCR-Fwd from forwarding noise and/or unintended signals due to an NCR movement or an environmental change, which may improve the performance of the NCR.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

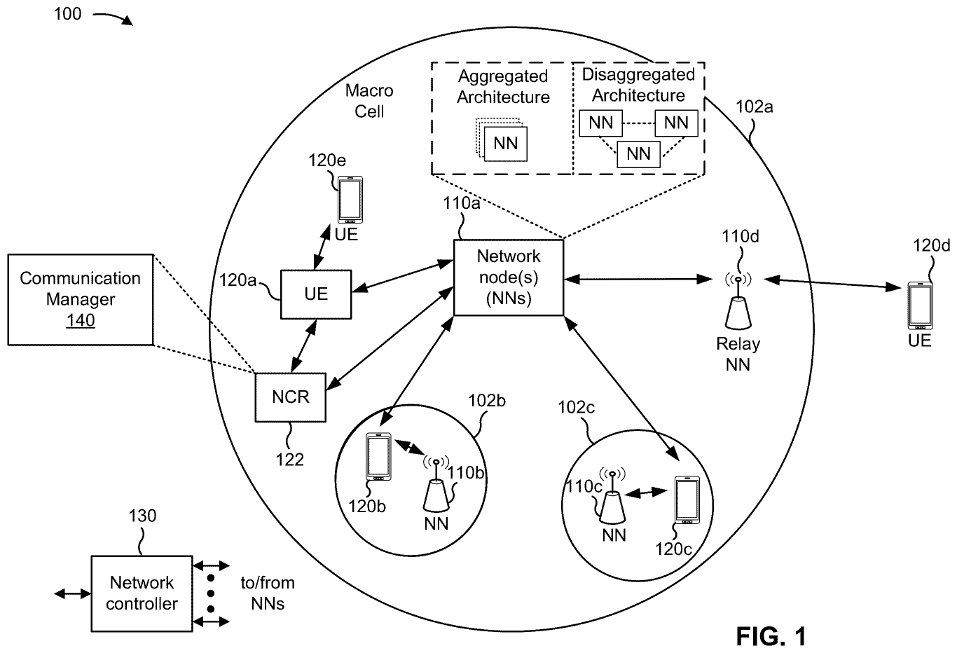

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (cMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FRI (410 MHz-7.125 GHZ) and FR2 (24.25 GHz-52.6 GHZ). It should be understood that although a portion of FR1 is greater than 6 GHz, FRI is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FRI, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FRI, FR2, FR3, FR4, FR4-a, FR4-1, and/or FR5) may be modified, and techniques described herein are applicable to those modified frequency ranges.

In some aspects, an NCR (e.g., NCR 122) may include a communication manager 140. As described in more detail elsewhere herein, the communication manager 140 may receive, by an NCR-MT of the NCR and via a control link, control information and an indication of a condition associated with a backhaul beam for RF signal forwarding to a network node; release, by the NCR-MT, an RRC connection of the NCR-MT with the network node; perform, by an NCR-Fwd of the NCR, the RF signal forwarding to the network node via the backhaul beam after the RRC connection of the NCR-MT is released and based at least in part on the control information; cease the RF signal forwarding on the backhaul beam based at least in part on an evaluation, by the NCR-MT or the NCR-Fwd, of the condition; and resume, by the NCR-MT, the RRC connection of the NCR-MT with the network node. Additionally, or alternatively, the communication manager 140 may perform one or more other operations described herein.

As indicated above, FIG. 1 is provided as an example. Other examples may differ from what is described with regard to FIG. 1.

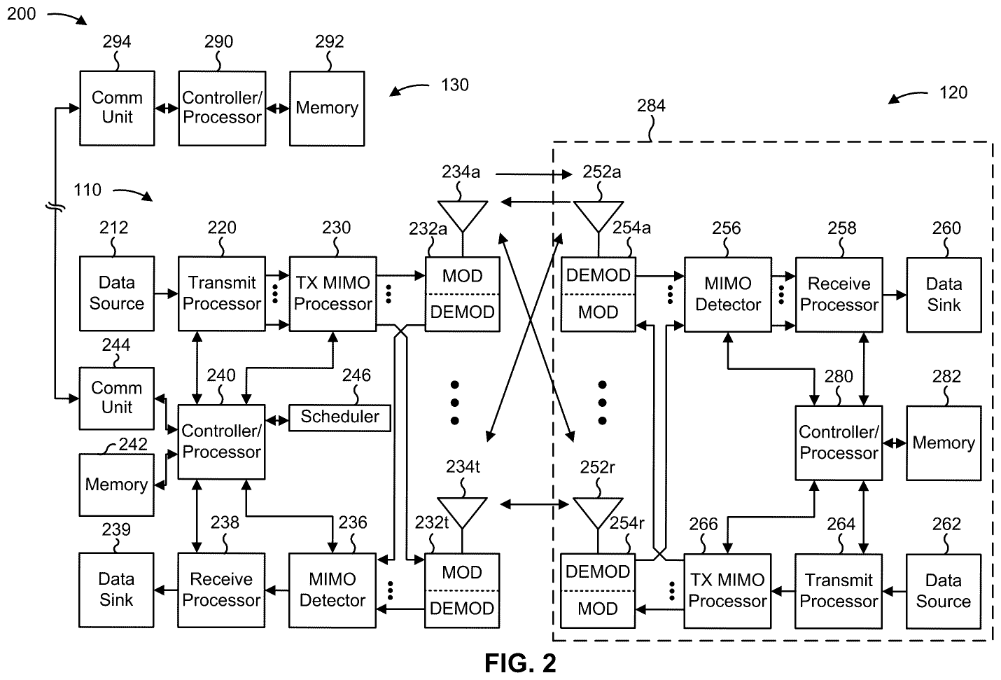

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

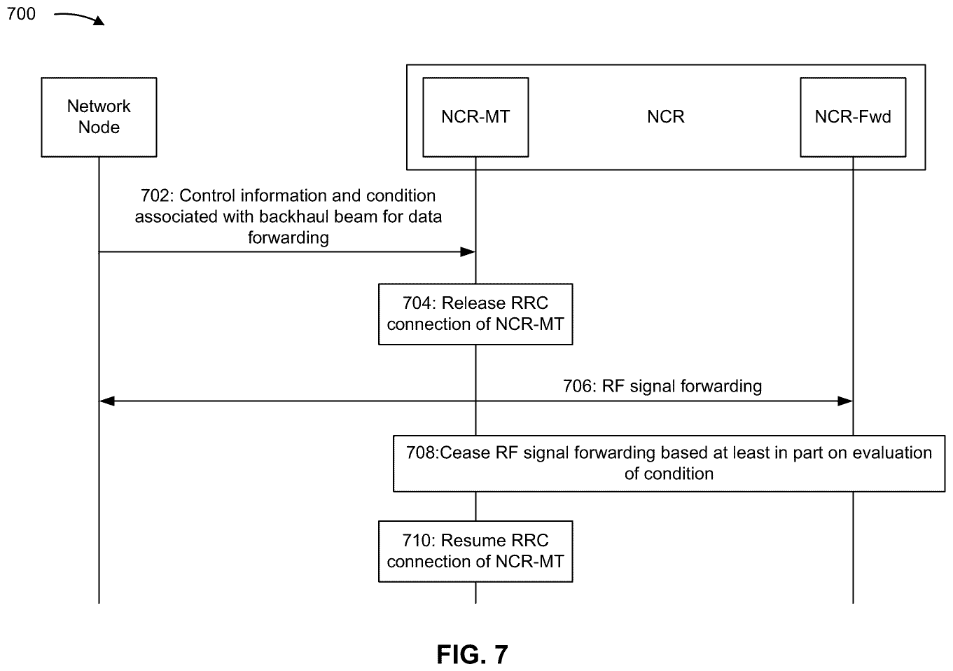

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-9).

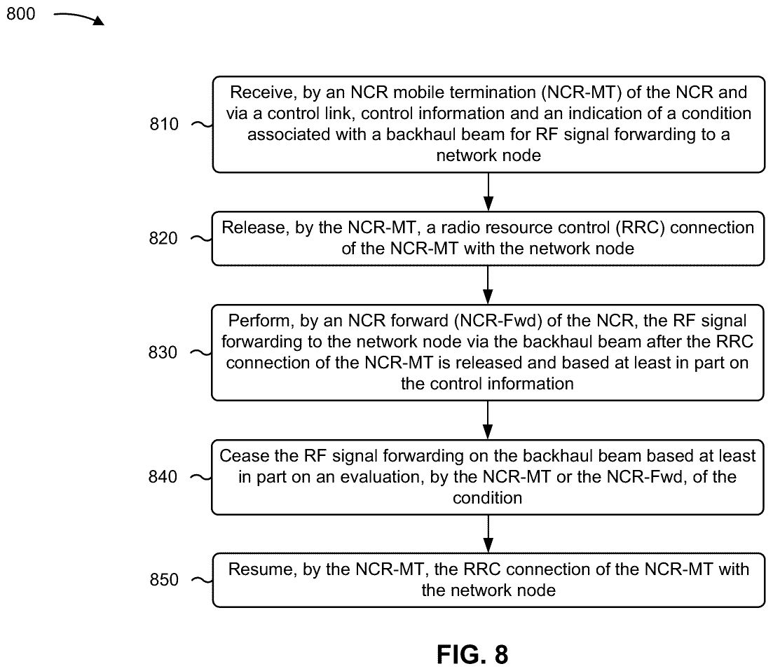

The controller/processor 240 of the network node 110, the controller/processor 280 of the UE 120, and/or any other component(s) of FIG. 2 may perform one or more techniques associated with evaluating backhaul beams for NCRs, as described in more detail elsewhere herein. In some aspects, the NCR described herein includes one or more components of the network node 110 shown in FIG. 2. In some aspects, the NCR described herein includes one or more components of the UE 120 shown in FIG. 2. For example, the controller/processor 240 of the network node 110, the controller/processor 280 of the UE 120, and/or any other component(s) of FIG. 2 may perform or direct operations of, for example, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, and/or other processes as described herein. In some examples, executing instructions may include running the instructions, converting the instructions, compiling the instructions, and/or interpreting the instructions, among other examples.

In some aspects, an NCR (e.g., NCR 122) includes means for receiving, by an NCR-MT of the NCR and via a control link, control information and an indication of a condition associated with a backhaul beam for RF signal forwarding to a network node; means for releasing, by the NCR-MT, an RRC connection of the NCR-MT with the network node; means for performing, by an NCR-Fwd of the NCR, the RF signal forwarding to the network node via the backhaul beam after the RRC connection of the NCR-MT is released and based at least in part on the control information; means for ceasing the RF signal forwarding on the backhaul beam based at least in part on an evaluation, by the NCR-MT or the NCR-Fwd, of the condition; and/or means for resuming, by the NCR-MT, the RRC connection of the NCR-MT with the network node. In some aspects, the means for the NCR to perform operations described herein may include, for example, one or more of transmit processor 220, TX MIMO processor 230, modem 232, antenna 234, MIMO detector 236, receive processor 238, controller/processor 240, memory 242, or scheduler 246. In some aspects, the means for the NCR to perform operations described herein may include, for example, one or more of antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (CNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

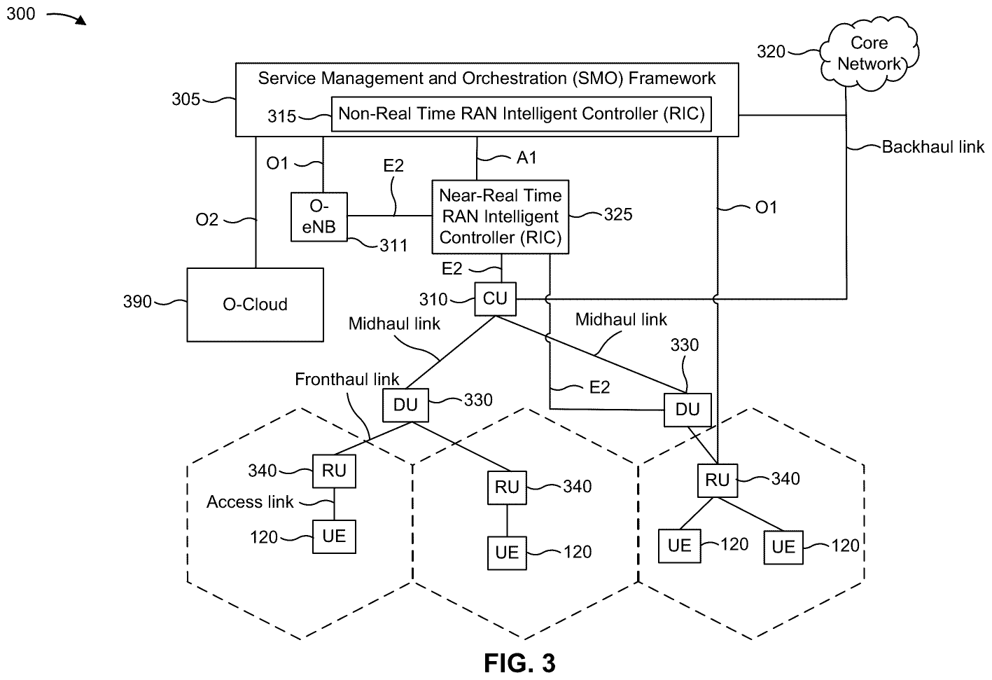

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective RF access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT

RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

An RF repeater may provide a cost-effective solution for extending a network coverage. However, an RF repeater may have various limitations. For example, an RF repeater may simply perform an amplify-and-forward operation, without being able to consider various factors that could improve performance. An NCR may be an enhancement over conventional RF repeaters. An NCR may have the capability to receive and process control information (or a side control configuration) from a network node. The control information may allow the NCR to perform the amplify-and-forward operation in a more efficient manner. For example, the control information may enable various benefits, such as a mitigation of unnecessary noise amplification, transmissions and receptions with better spatial directivity, and/or a simplified network integration.

An NCR, such as an NR NCR may be an in-band RF repeater used for extending a network coverage on FRI and FR2 bands based at least in part on an NCR model. The NCR may be a single hop stationary NCR. The NCR may be transparent to a UE. The NCR may maintain a network-node-repeater link and a repeater-UE link simultaneously. The NCR may support various control information for controlling an NCR-Fwd of the NCR. Such control information may include information regarding beamforming, an uplink-downlink (UL-DL) time division duplex (TDD), and/or on-off information.

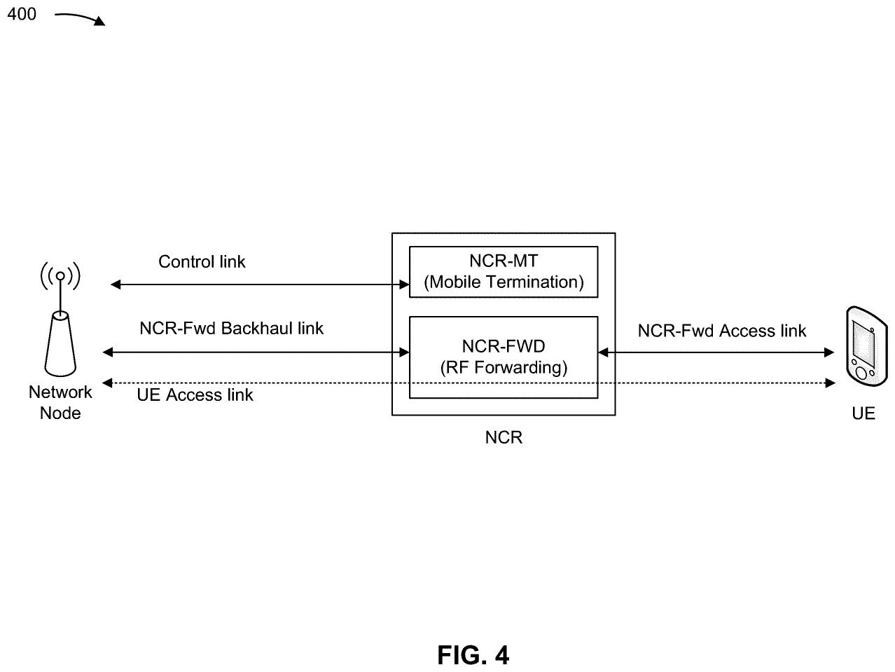

FIG. 4 is a diagram illustrating an example 400 of an NCR, in accordance with the present disclosure.

As shown in FIG. 4, an NCR may include an NCR-MT and an NCR-Fwd. The NCR-MT may be a functional entity configured to communicate with a network node (e.g., a gNB) via a control link between the NCR-MT and the network node. The control link may be based at least in part on an NR Uu interface. The NCR-MT may communicate with the network node to enable information exchanges (e.g., control information). A control of the NCR-Fwd may be based at least in part on the control information. The NCR-Fwd may be a functional entity configured to perform an amplify-and-forwarding of an uplink/downlink RF signal between the network node and a UE via a backhaul link and an access link. The NCR-Fwd may communicate with the network node via the backhaul link between the NCR-Fwd and the network node. The NCR-Fwd may communicate with the UE via the access link between the NCR-Fwd and the UE. A behavior of the NCR-Fwd may be controlled according to receiver control information from the network node. A UE access link between the network node and the UE may be via the NCR.

The NCR-MT, on the control link, may be associated with a unified transmission configuration indicator (TCI). The NCR-Fwd, on the backhaul link, may be associated with a fixed beam as a default. Adaptive beamforming may be an optional setting. A semi-static indication via a MAC control element (MAC-CE) on the backhaul link may indicate an NCR-MT beam (which may be RRC configured) via a downlink TCI, a sounding reference signal (SRS) resource indicator (SRI), or a unified TCI. An NCR-Fwd backhaul beam, when the NCR-MT and the NCR-Fwd are both simultaneously active, may correspond to the NCR-MT beam. The NCR-Fwd backhaul beam, when no explicit indication is provided, may follow a predefined rule, such that the NCR-Fwd backhaul beam may be based at least in part on a control resource set (CORESET) or a physical uplink control channel (PUCCH) with a lowest index or the unified TCI. Otherwise, the NCR-Fwd backhaul beam may be based at least in part on an explicitly indicated backhaul beam.

The NCR-Fwd, on the access link, may be associated with a periodic (e.g., RRC), a semi-persistent (e.g., MAC-CE and/or RRC), or an aperiodic (e.g., downlink control information (DCI) and/or MAC-CE) beam indication. One or multiple beams along with associated time resources may be indicated via the access link. Beam indices may refer to operations and management (OAM)-configured beams. An OAM may provide, to the network node and the NCR, the access link beam indication, which may provide information regarding a beam characterization. The beam characterization may be associated with a quantity of beams, spatial information, and/or a direction, and may be based at least in part on an implementation. The access link beam indication may be an implicit indication of an on state of the NCR-Fwd.

As indicated above, FIG. 4 is provided as an example. Other examples may differ from what is described with regard to FIG. 4.

A multi-beam operation may be defined for a cell selection or a cell reselection. For the cell selection in the multi-beam operation, a measurement quantity of a cell may depend on a UE implementation. For the cell reselection in the multi-beam operation, which may include an inter-RAT reselection from Evolved Universal Terrestrial Radio Access (E-UTRA) to NR, a measurement quantity of a cell may be derived by a UE from beams corresponding to the cell based at least in part on a synchronization signal (SS) and physical broadcast channel (PBCH) block. When a number of SS blocks to average (nrofSS-BlocksToAverage) (or a maximum reference signal index cell quality (maxRS-IndexCellQual) in E-UTRA) is not configured in a system information block (SIB) 2 or a SIB 4 (SIB 24 in E-UTRA), or when an absolute threshold SS blocks consolidation (absThreshSS-BlocksConsolidation) (or a threshold reference signal index (threshRS-Index) in E-UTRA) is not configured in the SIB 2 or SIB 4 (SIB 24 in E-UTRA), or when a highest beam measurement quality value, among a plurality of beam measurement quality values, is below or equal to the absThreshSS-BlocksConsolidation (threshRS-Index in E-UTRA), the cell measurement quantity may be derived by the UE as the highest beam measurement quantity value. Otherwise, the cell measurement quantity may be derived by the UE as a linear average of power values of up to nrofSS-BlocksToAverage (maxRS-IndexCellQual in E-UTRA) of highest beam measurement quantity values above the absThreshSS-BlocksConsolidation (threshRS-Index in E-UTRA).

When an NCR-MT is in an RRC connected mode, an NCR-Fwd may be ON or OFF following control information received from a network node. After the NCR-MT enters an RRC inactive mode, the NCR-Fwd may be ON or OFF following a last configuration received from the network node. The NCR-Fwd may be switched OFF when the NCR-MT in the RRC inactive mode reselects a different cell than a last serving cell on which the control information was received. After the cell reselection, the NCR-MT may resume so that the NCR-MT is able to receive control information from a new network node (e.g., via a network configuration). In some cases, the NCR-MT may move to an acceptable cell and then return back to a previous cell, or no acceptable cell may be found.

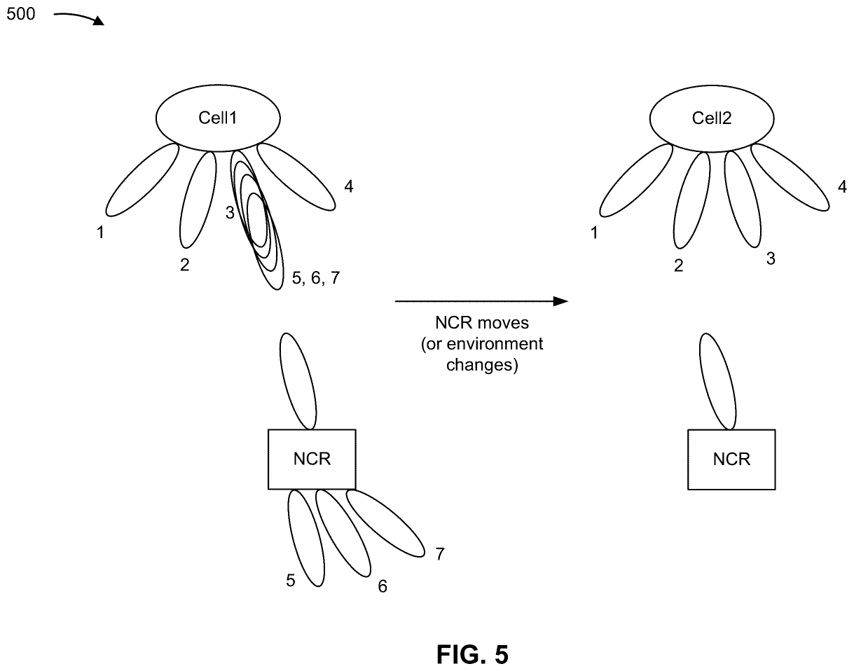

FIG. 5 is a diagram illustrating an example 500 of a cell reselection for an NCR, in accordance with the present disclosure.

As shown in FIG. 5, an NCR may be connected to a first cell. An NCR-MT, of the NCR, may be in an RRC inactive mode. The first cell may transmit a plurality of synchronization signal blocks (SSBs) (e.g., SSB 1, SSB 2, SSB 3, SSB 4, SSB 5, SSB 6, and SSB 7), which may be associated with a plurality of corresponding beams (e.g., beam 1, beam 2, beam 3, beam 4, beam 5, beam 6, and beam 7). The first cell may perform transmissions to the NCR using a subset of beams (e.g., beam 5, beam 6, and beam 7), of the plurality of beams. An NCR-Fwd, of the NCR, may amplify and forward the transmissions based at least in part on the subset of beams (e.g., beam 5, beam 6, and beam 7). The NCR-Fwd may receive the transmissions from the first cell based at least in part on control information. The control information may assume that the NCR points its backhaul beam in a direction of SSB 3 and fans out SSBs on occasions 5, 6, and 7, where SSB 5, SSB 6, and SSB 7 are quasi co-located with SSB 3.

After a certain period of time, the NCR may move to a different location, or the NCR may be associated with an environment change. The NCR-MT may perform a cell reselection, such that the NCR becomes connected to a second cell. After the cell reselection, the NCR may point its backhaul beam to an SSB of the second cell that is different from SSB 3 of the first cell, and thus, the control information may become invalid. The control information may be valid when receiving the transmissions from the first cell, but the control information may not be valid for the second cell. In this case, based at least in part on the cell reselection, the NCR-Fwd may be switched off, and the NCR-MT may resume a connection to receive new control information from a network node. The new control information may be valid for the second cell.

As indicated above, FIG. 5 is provided as an example. Other examples may differ from what is described with regard to FIG. 5.

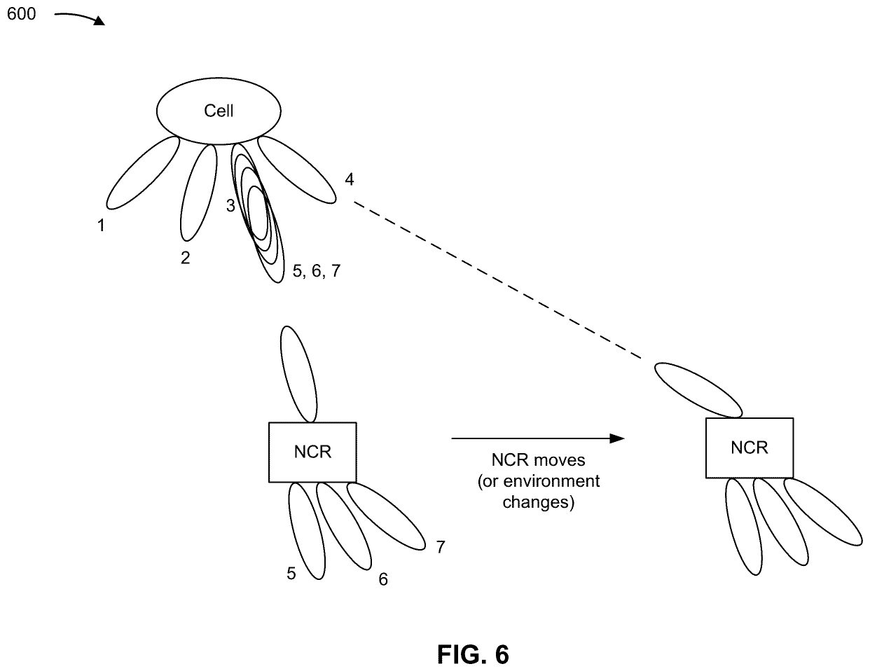

FIG. 6 is a diagram illustrating an example 600 of invalid control information for an NCR without a cell reselection, in accordance with the present disclosure.

As shown in FIG. 6, an NCR may be connected to a cell. An NCR-MT, of the NCR, may be in an RRC inactive mode. The cell may transmit a plurality of SSBs (e.g., SSB 1, SSB 2, SSB 3, SSB 4, SSB 5, SSB 6, and SSB 7), which may be associated with a plurality of corresponding beams (e.g., beam 1, beam 2, beam 3, beam 4, beam 5, beam 6, and beam 7). The first cell may perform transmissions to the NCR using a subset of beams (e.g., beam 5, beam 6, and beam 7), of the plurality of beams. An NCR-Fwd, of the NCR, may amplify and forward the transmissions based at least in part on the subset of beams (e.g., beam 5, beam 6, and beam 7). The NCR-Fwd may receive the transmissions from the cell based at least in part on control information. The control information may assume that the NCR points its backhaul beam in a direction of SSB 3 and fans out SSBs on occasions 5, 6, and 7, where SSB 5, SSB 6, and SSB 7 are quasi co-located with SSB 3.

After a certain period of time, the NCR may move to a different location, or the NCR may be associated with an environment change. The NCR-MT may still camp on the same cell (e.g., no cell reselection). A signal strength of beams associated with the cell may be observed by NCR changes. After the moving to the different location or after the environment change, the NCR may point its backhaul beam in a direction of SSB 4. When the NCR activates forwarding on SSB occasions 5, 6, and 7, the NCR may forward noise or an unintended signal, which may degrade a performance of the NCR. The NCR forwarding the noise or the unintended signal may imply that the control information has become invalid, but in this scenario (e.g., invalid control information with no cell reselection), the NCR does not have a mechanism to obtain new control information. A network node may be unaware of this change because cell reselection did not occur, and thus the NCR-MT may not resume a connection to the network node to obtain the new control information. Without the new control information, the NCR may forward the noise or the unintended signal.

As indicated above, FIG. 6 is provided as an example. Other examples may differ from what is described with regard to FIG. 6.

An SSB, as shown in FIG. 5 and FIG. 6, may be one example of a signal associated with stored control information that becomes invalid. However, other downlink/uplink transmissions or channels may also be associated with stored control information that becomes invalid. The other downlink/uplink transmissions may include UE-associated transmissions or non-UE associated transmissions (e.g., SSBs).

An NCR, when connected to a cell, may use control information to perform an amplify-and-forward operation. During the amplify-and-forward operation, an NCR-MT may be in an RRC inactive mode. An NCR-Fwd may perform the amplify-and-forward operation. The control information may assume that the NCR is pointing a backhaul beam towards the cell in a first direction, and the NCR-Fwd may perform the amplify-and-forward operation accordingly. When the NCR moves to a different location or is subjected to an environment change, the NCR may still camp on the same cell (e.g., no cell reselection), but now the NCR may be pointing the backhaul beam towards the cell in a second direction. However, the control information may not be useable for the second direction, so when the NCR-Fwd attempts to perform the amplify-and-forward operation using the control information, the NCR-Fwd may forward noise and/or an unintended signal, which may degrade a performance of the NCR. Further, since no cell reselection occurred, a network node may be unaware that the NCR moved to the different location or that the environment change occurred, and so the NCR-MT does not transition out of the RRC inactive mode to obtain updated control information that corresponds to the NCR pointing the backhaul beam towards the cell in the second direction.

In various aspects of techniques and apparatuses described herein, an NCR may receive, by an NCR-MT and from a network node via a control link, control information and an indication of a condition associated with a backhaul beam for RF signal forwarding to a network node. The NCR-MT may release an RRC connection of the NCR-MT with the network node. For example, the NCR-MT may transition from an RRC connected mode to an RRC inactive mode or an RRC idle mode. An NCR-Fwd may perform the RF signal forwarding to the network node via the backhaul beam after the RRC connection of the NCR-MT is released and based at least in part on the control information. The NCR-MT may perform beam measurements for the backhaul beam after the RRC connection of the NCR-MT is released (e.g., when the NCR-MT is in the RRC inactive mode or in the RRC idle mode). The NCR-MT or the NCR-Fwd may determine, based at least in part on an evaluation of the condition, that the backhaul beam is no longer suitable for the RF signal forwarding. For example, the NCR-MT may compare the beam measurements to a threshold value, associated with the condition, and when the beam measurements do not satisfy the threshold value, the NCR-MT or the NCR-Fwd may determine that the backhaul beam is no longer suitable for the RF signal forwarding. The backhaul beam not being suitable for the RF signal forwarding may also imply that the control information has become invalid. The NCR may cease the RF signal forwarding based at least in part on the evaluation, by the NCR-MT or the NCR-Fwd, of the condition. The NCR-MT may resume the RRC connection of the NCR-MT with the network node. For example, the NCR-MT may move back to the RRC connected mode. The NCR-MT may receive, from the network node, updated control information, which may be used for subsequent RF signal forwarding.

In some aspects, the NCR may determine when stored control information for an NCR becomes invalid based at least in part on a change of observed beam(s) of a camped cell. Measurements may be performed by the NCR, the NCR-MT, or the MCR-Fwd. The change of observed beam(s) may satisfy the condition, which may cause the NCR-MT to resume an RRC connection of the NCR-MT to receive the updated control information. The updated control information may stop the NCR-Fwd from forwarding noise and/or unintended signals due to an NCR movement or an environmental change. As a result, the performance of the NCR may be improved. Without defining the condition and performing the beam measurements of the backhaul beam, the NCR may be unable to determine when the stored control information has become invalid and when to resume the RRC connection of the NCR-MT to receive the updated control information.

FIG. 7 is a diagram illustrating an example 700 associated with evaluating backhaul beams for NCRs, in accordance with the present disclosure. As shown in FIG. 7, example 700 includes communication between an NCR (e.g., NCR 122) and a network node (e.g., network node 110). In some aspects, the NCR and the network node may be included in a wireless network, such as wireless network 100.

In some aspects, the NCR may include an NCR-MT and an NCR-Fwd. A UE may communicate with the NCR via an access link. The NCR may communicate with the network node via a control link or via a backhaul link.

In some aspects, in an NCR-MT connected mode, an NCR-MT beam may be the same as an NCR-Fwd beam, or alternatively, the NCR-MT beam may be different than the NCR-Fwd beam. In the NCR-MT connected mode, the NCR-MT may have an RRC connection of the NCR-MT with the network node. In some aspects, the NCR may be camped on a cell (e.g., the cell may be the camped cell). A beam of the cell may be designated as a backhaul beam for the NCR-Fwd to be used for RF signal forwarding, which may occur before or at a release of the RRC connection of the NCR-MT. A designation of the backhaul beam may be in an explicit manner, or in an implicit manner based at least in part on the NCR-MT beam in the NCR-MT connected mode.

As shown by reference number 702, the NCR-MT may receive, from the network node and via the control link, control information (e.g., side control information) and an indication of a condition associated with the backhaul beam for the RF signal forwarding to the network node. The NCR-MT may be a functional entity capable of receiving the side control information and the indication of the condition. The backhaul beam may be associated with the backhaul link. The RF signal forwarding may involve forwarding data from a UE to the network node. The control information (or side control configuration) may allow the NCR-Fwd to perform an amplify-and-forward operation in a more efficient manner. For example, the control information may indicate beam information for beams used to receive/forward data. The control information may be associated with controlling the NCR-Fwd. Such control information may include information regarding beamforming, an UL-DL TDD, and/or on-off information.

In some aspects, the NCR-MT may receive an indication of the backhaul beam to be used, following an RRC connection associated with the NCR-MT being released, for the RF signal forwarding. The NCR-MT may receive the indication of the backhaul beam to be used following the RRC connection release. In some aspects, the NCR-MT may determine the backhaul beam as a last beam used for RF signal forwarding before the RRC connection of the NCR-MT is released. The NCR-MT may determine the backhaul beam as the last beam used for forwarding before the NCR-MT releases the RRC connection of the NCR-MT. In some aspects, the NCR-MT may determine the backhaul beam as a last beam activated for RF signal forwarding before the RRC connection of the NCR-MT is released. The NCR-MT may determine the backhaul beam as the last beam activated for forwarding before the NCR-MT releases the RRC connection of the NCR-MT. In some aspects, the NCR-MT may determine the backhaul beam as a last beam used by the NCR-MT for NCR-MT-terminated traffic (e.g., an NCR-MT's access traffic or control traffic). In some aspects, the NCR-MT may determine the backhaul beam as a beam used by the NCR-MT to receive an RRC release message.

In some aspects, the backhaul beam may be associated with one or more reference signals (e.g., SSBs) forwarded by the NCR-Fwd before the RRC connection of the NCR-MT is released. The backhaul beam may be associated with the one or more reference signals (e.g., the SSBs) forwarded by the NCR-Fwd before the RRC connection release. In some aspects, the backhaul beam may be associated with an order of beam measurements reported by the NCR-MT before the RRC connection of the NCR-MT is released. The backhaul beam may be associated with the order of beam measurements reported by the NCR-MT before the RRC connection release (e.g., strongest beam(s) as indicated in a measurement report).

In some aspects, the backhaul beam and/or the condition may be associated with a direction for forwarding. Separate backhaul beams for forwarding may be defined for a downlink direction and an uplink direction, and separate conditions for forwarding may be defined for the downlink direction and the uplink direction. In other words, the NCR-MT may determine the separate backhaul beams for forwarding in a downlink and in an uplink, and/or the NCR-MT may receive the separate conditions for forwarding in the downlink and in the uplink.

In some aspects, the condition may indicate a threshold value for a beam measurement associated with the backhaul beam. An RRC connection associated with the NCR-MT may be resumed based at least in part on whether a detected beam measurement for the backhaul beam satisfies the threshold value. For example, whether the RRC connection of the NCR-MT is resumed may be based at least in part on whether a detected signal measurement for the backhaul beam is less than or greater than the threshold value. The threshold value may be an RSRP value, an RSRQ value, or a signal-to-interference-plus-noise ratio (SINR) value. The NCR-MT may receive, from the network node, the indication of the condition via a SIB or via RRC signaling.

In some aspects, the condition may be associated with a plurality of backhaul beams. The condition may indicate the threshold value for comparison with an average signal strength of the plurality of backhaul beams (e.g., a threshold value for comparison with the average signal strength of a set of backhaul beams). The set of backhaul beams may be the N strongest beams, or backhaul beams having measured signal strengths that fall above the threshold value. In some aspects, the indication of the condition may indicate a plurality of conditions associated with the same backhaul beam or different backhaul beams. The RRC connection of the NCR-MT may be resumed based at least in part on a fulfillment or a violation of one or more of the plurality of conditions. For example, the RRC connection resume may be based at least in part on the fulfillment/violation of any or all of the plurality of conditions.

In some aspects, the network node may provide the indication of one or more conditions (e.g., conditions on measurements) to the NCR-MT for the designated backhaul beam. The one or more conditions may include different measurement thresholds. The network node may provide the indication of the one or more conditions before or at the release of the RRC connection of the NCR-MT.

As shown by reference number 704, the NCR-MT may release the RRC connection of the NCR-MT with the network node. The NCR-MT may release the RRC connection of the NCR-MT after receiving the control information and the condition associated with the backhaul beam for forwarding, as the RRC connection of the NCR-MT with the network node may no longer be needed after the NCR-MT receives the control information and the condition. The NCR-MT, when releasing the RRC connection of the NCR-MT, may transition from an RRC connected mode to an RRC inactive mode or an RRC idle mode. For example, releasing the RRC connection of the NCR-MT may transition the NCR-MT to the RRC inactive mode or the RRC idle mode.

As shown by reference number 706, the NCR-Fwd may perform the RF signal forwarding to the network node via the backhaul beam after the RRC connection of the NCR-MT is released. The NCR-Fwd may be a functional entity capable of performing the RF signal forwarding. The NCR-Fwd may perform the RF signal forwarding based at least in part on the control information (e.g., using the beam information indicated in the control information). The RF signal forwarding may include an amplify and forward operation for data received from a UE. In some aspects, after the RRC connection of the NCR-MT is released, the NCR-MT, which may be in the RRC inactive mode or the RRC idle mode, may perform beam measurements for the backhaul beam. The beam measurements for the backhaul beam may be indicative of a cell quality for a camped cell associated with the NCR. Measurements to assess cell quality for the camped cell may occur in the RRC inactive mode or the RRC idle mode after the RRC connection of the NCR-MT is released. In some aspects, the RF signal forwarding may be in an uplink direction or in a downlink direction. The RF signal forwarding may include an RF signal forwarding, or the RF signal forwarding may include an RF signal amplifying and forwarding. A signal forwarded may be a UE-associated signal (e.g., a dedicated UE traffic channel) or a non-UE-associated signal (e.g., an SSB or a SIB).

As shown by reference number 708, the NCR-MT or the NCR-Fwd may determine, based at least in part on an evaluation of the condition, that the backhaul beam is no longer suitable for the RF signal forwarding. The condition, when fulfilled, may indicate that the backhaul beam is suitable. Alternatively, the condition, when fulfilled, may indicate that the backhaul beam is not suitable. As an example, the beam measurements associated with the backhaul beam may not satisfy the threshold value, which may indicate that the backhaul beam is of relatively poor quality and is no longer suitable to be used for the RF signal forwarding. The condition being satisfied may not be associated with a cell reselection for the NCR. Rather, the condition may be satisfied based at least in part on a movement of the NCR or a changed environment (e.g., an object blocking the NCR) associated with the NCR. The NCR-MT or the NCR-Fwd may determine, based at least in part on the evaluation of the condition relative to the beam measurements, that the backhaul beam is no longer adequate for the RF signal forwarding (e.g., an evaluation of the condition is made to determine whether the beam is favorable or not favorable). The NCR may cease the RF signal forwarding based at least in part on the evaluation, by the NCR-MT or the NCR-Fwd, of the condition.

As shown by reference number 710, the NCR-MT may resume the RRC connection of the NCR-MT with the network node. The NCR-MT may receive, from the network node and after the RRC connection of the NCR-MT is resumed, updated control information. The updated control information may indicate updated beam information, which may be based at least in part on the movement of the NCR or the changed environment associated with the NCR. The NCR-MT may resume the RRC connection of the NCR-MT in order to receive the updated control information. The NCR-Fwd may be switched off based at least in part on the RRC connection of the NCR-MT being resumed.

In some aspects, the RRC connection of the NCR-MT may be released, which may cause the NCR-MT to move into the RRC inactive mode. When the NCR-MT is in the RRC inactive mode, the NCR-MT may perform measurements of the designated backhaul beams. The NCR-MT may compute an overall cell quality value for the cell based at least in part on the measurements of the designated backhaul beams. Depending on the overall cell quality for the cell, the NCR-MT may assess whether or not to perform a cell reselection for the NCR. The NCR-MT may perform a multi-beam operation to evaluate whether the cell reselection is needed. The NCR, via the NCR-MT or the NCR-Fwd, may evaluate the one or more conditions, such that the NCR may determine whether the measurements of the designated backhaul beams satisfies the one or more conditions. The NCR, via the NCR-MT or the NCR-Fwd, may determine whether stored control information for an NCR operation has become invalid based at least in part on a change of observed beam(s), as indicated by the measurements of the designated backhaul beams in relation to the one or more conditions.

In some aspects, when no cell reselection occurs and the evaluation of the one or more conditions indicates that the designated backhaul beams are still favorable (e.g., measurements associated with the designated backhaul beams satisfy a threshold), the NCR may remain operational using last stored control information. In other words, the control information that is already stored in the NCR may still be valid. Otherwise, when the evaluation of the one or more conditions indicates that the designated backhaul beams are not favorable (e.g., the measurements associated with the designated backhaul beams do not satisfy the threshold), the NCR-Fwd may be switched off and the NCR-MT may resume the RRC connection of the NCR-MT with the network node. The NCR-MT may move from the RRC inactive mode to the NCR-MT connected mode, which may allow the NCR to receive the updated control information from the network node.

As indicated above, FIG. 7 is provided as an example. Other examples may differ from what is described with regard to FIG. 7.

FIG. 8 is a diagram illustrating an example process 800 performed, for example, by an NCR, in accordance with the present disclosure. Example process 800 is an example where the NCR (e.g., NCR 122) performs operations associated with evaluating backhaul beams for NCRs.

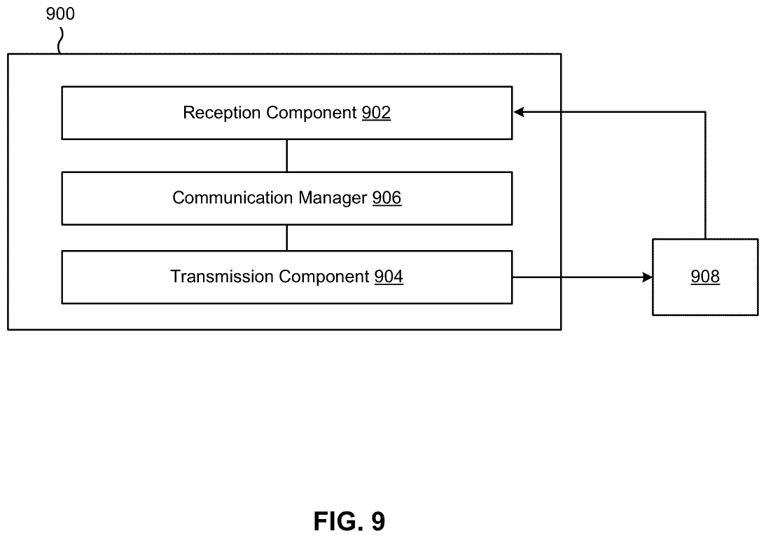

As shown in FIG. 8, in some aspects, process 800 may include receiving, by an NCR-MT of the NCR and via a control link, control information and an indication of a condition associated with a backhaul beam for RF signal forwarding to a network node (block 810). For example, the NCR (e.g., using reception component 902 and/or communication manager 906, depicted in FIG. 9) may receive, by an NCR-MT of the NCR and via a control link, control information and an indication of a condition associated with a backhaul beam for RF signal forwarding to a network node, as described above.

As further shown in FIG. 8, in some aspects, process 800 may include releasing, by the NCR-MT, an RRC connection of the NCR-MT with the network node (block 820). For example, the NCR (e.g., using communication manager 906, depicted in FIG. 9) may release, by the NCR-MT, an RRC connection of the NCR-MT with the network node, as described above.

As further shown in FIG. 8, in some aspects, process 800 may include performing, by an NCR-Fwd of the NCR, the RF signal forwarding to the network node via the backhaul beam after the RRC connection of the NCR-MT is released and based at least in part on the control information (block 830). For example, the NCR (e.g., using communication manager 906, depicted in FIG. 9) may perform, by an NCR-Fwd of the NCR, the RF signal forwarding to the network node via the backhaul beam after the RRC connection of the NCR-MT is released and based at least in part on the control information, as described above.

As further shown in FIG. 8, in some aspects, process 800 may include ceasing the RF signal forwarding on the backhaul beam based at least in part on an evaluation, by the NCR-MT or the NCR-Fwd, of the condition (block 840). For example, the NCR (e.g., using communication manager 906, depicted in FIG. 9) may cease the RF signal forwarding on the backhaul beam based at least in part on an evaluation, by the NCR-MT or the NCR-Fwd, of the condition, as described above.

As further shown in FIG. 8, in some aspects, process 800 may include

resuming, by the NCR-MT, the RRC connection of the NCR-MT with the network node (block 850). For example, the NCR (e.g., using communication manager 906, depicted in FIG. 9) may resume, by the NCR-MT, the RRC connection of the NCR-MT with the network node, as described above.

Process 800 may include additional aspects, such as any single aspect or any combination of aspects described below and/or in connection with one or more other processes described elsewhere herein.

In a first aspect, process 800 includes transitioning the NCR-MT from an RRC connected mode to an RRC inactive mode or an RRC idle mode.

In a second aspect, alone or in combination with the first aspect, process 800 includes receiving, by the NCR-MT, an indication of the backhaul beam to be used, following the RRC connection being released, for the RF signal forwarding.

In a third aspect, alone or in combination with one or more of the first and second aspects, process 800 includes determining, by the NCR-MT, the backhaul beam as a last beam used for RF signal forwarding before the RRC connection is released.

In a fourth aspect, alone or in combination with one or more of the first through third aspects, process 800 includes determining, by the NCR-MT, the backhaul beam as a last beam activated for RF signal forwarding before the RRC connection is released.

In a fifth aspect, alone or in combination with one or more of the first through fourth aspects, process 800 includes determining, by the NCR-MT, the backhaul beam as a last beam used by the NCR-MT for NCR-MT-terminated traffic.

In a sixth aspect, alone or in combination with one or more of the first through fifth aspects, process 800 includes determining, by the NCR-MT, the backhaul beam as a beam used by the NCR-MT to receive an RRC release message.

In a seventh aspect, alone or in combination with one or more of the first through sixth aspects, the backhaul beam is associated with one or more reference signals forwarded by the NCR-Fwd before the RRC connection is released, and the one or more reference signals include one or more SSBs.

In an eighth aspect, alone or in combination with one or more of the first through seventh aspects, the backhaul beam is associated with an order of beam measurements reported by the NCR-MT before the RRC connection is released.

In a ninth aspect, alone or in combination with one or more of the first through eighth aspects, one or more of the backhaul beam or the condition are associated with a direction for forwarding, separate backhaul beams for forwarding are defined for a downlink direction and an uplink direction, and separate conditions for forwarding are defined for the downlink direction and the uplink direction.

In a tenth aspect, alone or in combination with one or more of the first through ninth aspects, the condition indicates a threshold value for a beam measurement associated with the backhaul beam, and the RRC connection is resumed based at least in part on whether a detected beam measurement for the backhaul beam satisfies the threshold value.

In an eleventh aspect, alone or in combination with one or more of the first through tenth aspects, the indication of the condition is received via a SIB or via RRC signaling.

In a twelfth aspect, alone or in combination with one or more of the first through eleventh aspects, the condition is associated with a plurality of backhaul beams, and the condition includes a threshold value for comparison with an average signal strength of the plurality of backhaul beams.

In a thirteenth aspect, alone or in combination with one or more of the first through twelfth aspects, the indication indicates a plurality of conditions associated with a same backhaul beam or different backhaul beams, and the RRC connection is resumed based at least in part on a fulfillment or a violation of one or more of the plurality of conditions.

In a fourteenth aspect, alone or in combination with one or more of the first through thirteenth aspects, process 800 includes performing, by the NCR-MT, beam measurements for the backhaul beam after the RRC connection is released, wherein the beam measurements for the backhaul beam are indicative of a cell quality for a camped cell associated with the NCR, and the condition is satisfied based at least in part on the beam measurements.

In a fifteenth aspect, alone or in combination with one or more of the first through fourteenth aspects, process 800 includes receiving, by the NCR-MT and after the RRC connection is resumed, updated control information, and the updated control information is based at least in part on a movement of the NCR or a changed environment associated with the NCR.

In a sixteenth aspect, alone or in combination with one or more of the first through fifteenth aspects, the condition being satisfied is not associated with a cell reselection for the NCR.

In a seventeenth aspect, alone or in combination with one or more of the first through sixteenth aspects, the NCR-Fwd is switched off based at least in part on the RRC connection being resumed.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be an NCR, or an NCR may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIG. 7. Additionally, or alternatively, the apparatus 900 may be configured to perform one or more processes described herein, such as process 800 of FIG. 8. In some aspects, the apparatus 900 and/or one or more components shown in FIG. 9 may include one or more components of the NCR described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the NCR described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the NCR described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive, by an NCR-MT of the NCR and via a control link, control information and an indication of a condition associated with a backhaul beam for RF signal forwarding to a network node. The communication manager 906 may release, by the NCR-MT, an RRC connection of the NCR-MT with the network node. The communication manager 906 may perform, by an NCR-Fwd of the NCR, the RF signal forwarding to the network node via the backhaul beam after the RRC connection of the NCR-MT is released and based at least in part on the control information. The communication manager 906 may cease the RF signal forwarding on the backhaul beam based at least in part on an evaluation, by the NCR-MT or the NCR-Fwd, of the condition. The communication manager 906 may resume, by the NCR-MT, the RRC connection of the NCR-MT with the network node.

The communication manager 906 may transition the NCR-MT from an RRC connected mode to an RRC inactive mode or an RRC idle mode. The reception component 902 may receive, by the NCR-MT, an indication of the backhaul beam to be used, following the RRC connection being released, for the RF signal forwarding. The communication manager 906 may determine, by the NCR-MT, the backhaul beam as a last beam used for RF signal forwarding before the RRC connection is released. The communication manager 906 may determine, by the NCR-MT, the backhaul beam as a last beam activated for RF signal forwarding before the RRC connection is released. The communication manager 906 may determine, by the NCR-MT, the backhaul beam as a last beam used by the NCR-MT for NCR-MT-terminated traffic. The communication manager 906 may determine, by the NCR-MT, the backhaul beam as a beam used by the NCR-MT to receive an RRC release message.

The communication manager 906 may perform, by the NCR-MT, beam measurements for the backhaul beam after the RRC connection is released, wherein the beam measurements for the backhaul beam are indicative of a cell quality for a camped cell associated with the NCR, and the condition is satisfied based at least in part on the beam measurements. The reception component 902 may receive, by the NCR-MT and after the RRC connection is resumed, updated control information, and the updated control information is based at least in part on a movement of the NCR or a changed environment associated with the NCR.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a network-controlled repeater (NCR), comprising: receiving, by an NCR mobile termination (NCR-MT) of the NCR and via a control link, control information; releasing, by the NCR-MT, a radio resource control (RRC) connection of the NCR-MT with a network node; performing, by an NCR forward (NCR-Fwd) of the NCR, a radio frequency (RF) signal forwarding to the network node via a backhaul beam after the RRC connection of the NCR-MT is released and based at least in part on the control information; ceasing the RF signal forwarding on the backhaul beam based at least in part on an evaluation, by the NCR-MT or the NCR-Fwd, of a condition associated with the backhaul beam for the RF signal forwarding to the network node; and resuming, by the NCR-MT, the RRC connection of the NCR-MT with the network node.

Aspect 2: The method of Aspect 1, wherein releasing the RRC connection comprises transitioning the NCR-MT from an RRC connected mode to an RRC inactive mode or an RRC idle mode.

Aspect 3: The method of any of Aspects 1-2, further comprising: receiving, by the NCR-MT, an indication of the backhaul beam to be used, following the RRC connection being released, for the RF signal forwarding.

Aspect 4: The method of any of Aspects 1-3, further comprising: determining, by the NCR-MT, the backhaul beam as a last beam used for RF signal forwarding before the RRC connection is released.

Aspect 5: The method of any of Aspects 1-4, further comprising: determining, by the NCR-MT, the backhaul beam as a last beam activated for RF signal forwarding before the RRC connection is released.

Aspect 6: The method of any of Aspects 1-5, further comprising: determining, by the NCR-MT, the backhaul beam as a last beam used by the NCR-MT for NCR-MT-terminated traffic.

Aspect 7: The method of any of Aspects 1-6, further comprising: determining, by the NCR-MT, the backhaul beam as a beam used by the NCR-MT to receive an RRC release message.

Aspect 8: The method of any of Aspects 1-7, wherein the backhaul beam is associated with one or more reference signals forwarded by the NCR-Fwd before the RRC connection is released, and the one or more reference signals include one or more synchronization signal blocks (SSBs).

Aspect 9: The method of any of Aspects 1-8, wherein the backhaul beam is associated with an order of beam measurements reported by the NCR-MT before the RRC connection is released.

Aspect 10: The method of any of Aspects 1-9, wherein one or more of the backhaul beam or the condition are associated with a direction for forwarding, separate backhaul beams for forwarding are defined for a downlink direction and an uplink direction, and separate conditions for forwarding are defined for the downlink direction and the uplink direction.

Aspect 11: The method of any of Aspects 1-10, wherein the condition indicates a threshold value for a beam measurement associated with the backhaul beam, and the RRC connection is resumed based at least in part on whether a detected beam measurement for the backhaul beam satisfies the threshold value.

Aspect 12: The method of any of Aspects 1-11, wherein the condition is associated with a plurality of backhaul beams, and the condition includes a threshold value for comparison with an average signal strength of the plurality of backhaul beams.

Aspect 13: The method of any of Aspects 1-12, further comprising: performing, by the NCR-MT, beam measurements for the backhaul beam after the RRC connection is released, wherein the beam measurements for the backhaul beam are indicative of a cell quality for a camped cell associated with the NCR, and the condition is satisfied based at least in part on the beam measurements.

Aspect 14: The method of any of Aspects 1-13, further comprising: receiving, by the NCR-MT and after the RRC connection is resumed, updated control information, and the updated control information is based at least in part on a movement of the NCR or a changed environment associated with the NCR.

Aspect 15: The method of any of Aspects 1-14, wherein the condition being satisfied is not associated with a cell reselection for the NCR.

Aspect 16: The method of any of Aspects 1-15, wherein the NCR-Fwd is switched off based at least in part on the RRC connection being resumed.

Aspect 17: An apparatus for wireless communication at a device, comprising a processor; memory coupled with the processor; and instructions stored in the memory and executable by the processor to cause the apparatus to perform the method of one or more of Aspects 1-16.

Aspect 18: A device for wireless communication, comprising a memory and one or more processors coupled to the memory, the one or more processors configured to perform the method of one or more of Aspects 1-16.

Aspect 19: An apparatus for wireless communication, comprising at least one means for performing the method of one or more of Aspects 1-16.

Aspect 20: A non-transitory computer-readable medium storing code for wireless communication, the code comprising instructions executable by a processor to perform the method of one or more of Aspects 1-16.

Aspect 21: A non-transitory computer-readable medium storing a set of instructions for wireless communication, the set of instructions comprising one or more instructions that, when executed by one or more processors of a device, cause the device to perform the method of one or more of Aspects 1-16.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a network-controlled repeater (NCR), comprising:
one or more memories; and
one or more processors, coupled to the one or more memories, configured to cause the NCR to:
receive, by an NCR mobile termination (NCR-MT) of the NCR and via a control link, control information;
release, by the NCR-MT, a radio resource control (RRC) connection of the NCR-MT with a network node;
perform, by an NCR forward (NCR-Fwd) of the NCR, a radio frequency (RF) signal forwarding to the network node via a backhaul beam after the RRC connection of the NCR-MT is released and based at least in part on the control information; and
cease the RF signal forwarding on the backhaul beam based at least in part on an evaluation, by the NCR-MT or the NCR-Fwd, of a condition associated with the backhaul beam for the RF signal forwarding to the network node.

2. The apparatus of claim 1, wherein the one or more processors are further configured to cause the NCR to:
resume, by the NCR-MT, the RRC connection of the NCR-MT with the network node.

3. The apparatus of claim 1, wherein the one or more processors, to release the RRC connection, are configured to cause the NCR to:
transition the NCR-MT from an RRC connected mode to an RRC inactive mode or an RRC idle mode.

4. The apparatus of claim 1, wherein the one or more processors are further configured to cause the NCR to:
receive, by the NCR-MT, an indication of the backhaul beam to be used, following the RRC connection being released, for the RF signal forwarding.

5. The apparatus of claim 1, wherein the one or more processors are further configured to cause the NCR to:
determine, by the NCR-MT, the backhaul beam as a last beam used for RF signal forwarding before the RRC connection is released.

6. The apparatus of claim 1, wherein the one or more processors are further configured to cause the NCR to:
determine, by the NCR-MT, the backhaul beam as a last beam activated for RF signal forwarding before the RRC connection is released.

7. The apparatus of claim 1, wherein the one or more processors are further configured to cause the NCR to:
determine, by the NCR-MT, the backhaul beam as a last beam used by the NCR-MT for NCR-MT-terminated traffic.

8. The apparatus of claim 1, wherein the one or more processors are further configured to cause the NCR to:
determine, by the NCR-MT, the backhaul beam as a beam used by the NCR-MT to receive an RRC release message.

9. The apparatus of claim 1, wherein the backhaul beam is associated with one or more reference signals forwarded by the NCR-Fwd before the RRC connection is released, and the one or more reference signals include one or more synchronization signal blocks (SSBs).

10. The apparatus of claim 1, wherein the backhaul beam is associated with an order of beam measurements reported by the NCR-MT before the RRC connection is released.

11. The apparatus of claim 1, wherein one or more of the backhaul beam or the condition are associated with a direction for forwarding, separate backhaul beams for forwarding are defined for a downlink direction and an uplink direction, and separate conditions for forwarding are defined for the downlink direction and the uplink direction.

12. The apparatus of claim 1, wherein the condition indicates a threshold value for a beam measurement associated with the backhaul beam, and the RRC connection is resumed based at least in part on whether a detected beam measurement for the backhaul beam satisfies the threshold value.

13. The apparatus of claim 1, wherein the one or more processors are further configured to cause the NCR to:
receive, via a system information block (SIB) or via RRC signaling, an indication of the condition.

14. The apparatus of claim 1, wherein the condition is associated with a plurality of backhaul beams, and the condition includes a threshold value for comparison with an average signal strength of the plurality of backhaul beams.

15. The apparatus of claim 1, wherein the one or more processors are further configured to cause the NCR to:
perform, by the NCR-MT, beam measurements for the backhaul beam after the RRC connection is released, wherein the beam measurements for the backhaul beam are indicative of a cell quality for a camped cell associated with the NCR, and the condition is satisfied based at least in part on the beam measurements.

16. The apparatus of claim 1, wherein the one or more processors are further configured to cause the NCR to:
receive, by the NCR-MT and after the RRC connection is resumed, updated control information, and the updated control information is based at least in part on a movement of the NCR or a changed environment associated with the NCR.

17. The apparatus of claim 1, wherein the condition being satisfied is not associated with a cell reselection for the NCR.

18. The apparatus of claim 1, wherein the one or more processors are further configured to cause the NCR to:
switch off the NCR-Fwd based at least in part on the RRC connection being resumed.

19. A method of wireless communication performed by a network-controlled repeater (NCR), comprising:
receiving, by an NCR mobile termination (NCR-MT) of the NCR and via a control link, control information;
releasing, by the NCR-MT, a radio resource control (RRC) connection of the NCR-MT with a network node;
performing, by an NCR forward (NCR-Fwd) of the NCR, a radio frequency (RF) signal forwarding to the network node via a backhaul beam after the RRC connection of the NCR-MT is released and based at least in part on the control information; and
ceasing the RF signal forwarding on the backhaul beam based at least in part on an evaluation, by the NCR-MT or the NCR-Fwd, of a condition associated with the backhaul beam for the RF signal forwarding to the network node.

20. A non-transitory computer-readable medium storing a set of instructions for wireless communication, the set of instructions comprising:
one or more instructions that, when executed by one or more processors of a network-controlled repeater (NCR), cause the NCR to:
receive, by an NCR mobile termination (NCR-MT) of the NCR and via a control link, control information;
release, by the NCR-MT, a radio resource control (RRC) connection of the NCR-MT with a network node;
perform, by an NCR forward (NCR-Fwd) of the NCR, a radio frequency (RF) signal forwarding to the network node via a backhaul beam after the RRC connection of the NCR-MT is released and based at least in part on the control information; and
cease the RF signal forwarding on the backhaul beam based at least in part on an evaluation, by the NCR-MT or the NCR-Fwd, of a condition associated with the backhaul beam for the RF signal forwarding to the network node.
